(19) United States
(12) Patent Application Publication
(10) Pub. No.: US 2014/0065489 A1
(43) Pub. Date: Mar. 6, 2014

(54) ELECTROLYTE-NEGATIVE ELECTRODE STRUCTURE, AND LITHIUM ION SECONDARY BATTERY COMPRISING THE SAME

(71) Applicant: HONDA MOTOR CO., LTD., TOKYO (JP)

(72) Inventors: Kazuki SAIMEN, SAITAMA (JP); Yuki ITO, SAITAMA (JP)

(73) Assignee: HONDA MOTOR CO., LTD., TOKYO (JP)

(21) Appl. No.: 13/968,919

(22) Filed: Aug. 16, 2013

(30) Foreign Application Priority Data
Aug. 28, 2012 (JP) 2012-187324

(51) Int. Cl. H01M 4/62; H01M 10/0565; H01M 10/0525

(52) U.S. Cl. CPC H01M 4/622; H01M 10/0525; H01M 10/0565
USPC 429/303

(57) ABSTRACT

There are provided a constitution which can suppress a decrease in the cycle performance in repetition of charging and discharging, and a lithium ion secondary battery comprising the constitution. An electrolyte-negative electrode structure (7) comprises: a negative electrode (4) in which a negative electrode active material layer (3) comprising a material capable of intercalating lithium ions is formed on a current collector (2); and a solid electrolyte (6) comprising an inorganic particle having lithium ion conductivity, a polymer gel to be impregnated with an electrolyte solution, and an organic polymer acting as a binder for the inorganic particle and being capable of being impregnated with the polymer gel, wherein the negative electrode active material layer (3) and the solid electrolyte (6) are unified through the organic polymer as a medium.

### BACKGROUND OF THE INVENTION

1. Field of the Invention

The present invention relates to an electrolyte-negative electrode structure, and a lithium ion secondary battery comprising the same.

2. Description of the Related Art

In lithium ion secondary batteries, in order to enlarge the battery capacity, there has recently been studied the use of a high-capacity material such as silicon, silicon oxide and tin oxide as a negative electrode active material. The high-capacity material reacts with lithium ions and forms a compound to be thereby able to intercalate lithium ions. The lithium ion secondary battery is proposed which comprises a negative electrode in which a negative electrode active material layer comprising silicon is vapor-deposited on a copper foil as a current collecting plate, and an electrolyte in which a separator arranged in contact with the negative electrode is impregnated with an electrolyte solution in which a supporting salt is dissolved in an organic solvent (see International Publication No. WO 01/029913).

However, in the lithium ion secondary battery, the negative electrode active material layer largely expands and contracts along with intercalation and deintercalation of lithium ions by charging and discharging. As a result, repetition of charging and discharging generates cracks in the negative electrode active material layer due to stresses generated by the expansion or contraction, and the negative electrode active material layer exfoliates from the current collecting plate, thereby causing the disadvantage of a decrease in the cycle performance.

It is an object of the present invention to provide a constitution capable of eliminating such a disadvantage and suppressing a decrease in the cycle performance in repetition of charging and discharging. It is also another object of the present invention to provide a lithium ion secondary battery having the constitution.

### SUMMARY OF THE INVENTION

In order to achieve such objects, the present invention provides an electrolyte-negative electrode structure used for a lithium ion secondary battery, comprising: a negative electrode in which a negative electrode active material layer comprising a material capable of intercalating lithium ions is formed on a current collector; and a solid electrolyte comprising an inorganic particle having lithium ion conductivity, a polymer gel to be impregnated with an electrolyte solution having lithium ion conductivity, and an organic polymer acting as a binder for the inorganic particle and being capable of being impregnated with the polymer gel, wherein the negative electrode active material layer and the solid electrolyte are unified through the organic polymer as a medium.

The electrolyte-negative electrode structure according to the present invention is configured such that the negative electrode active material layer formed on the current collector and the solid electrolyte are joined and unified through the organic polymer. As a result, when the electrolyte-negative electrode structure is used for a lithium ion secondary battery, even if the negative electrode active material layer repeats expansion and contraction along with charging and discharging, stresses generated by the repetition of expansion and contraction can be relaxed by the solid electrolyte.

Therefore, according to the electrolyte-negative electrode structure according to the present invention, exfoliation of the negative electrode active material layer from the current collecting plate can be prevented and a decrease in the cycle performance can be suppressed.

In the electrolyte-negative electrode structure according to the present invention, by making the volume ratio of the inorganic particle to the organic polymer in the range of 54:46 to 91:9, a structure as the solid electrolyte can securely be formed.

In the case where the volume ratio of the inorganic particle to the organic polymer is lower than 54:46, that is, in the case where the proportion of the inorganic particle is below 54/100, the solid electrolyte cannot provide excellent lithium ion conductivity in some cases. On the other hand, in the case where the volume ratio of the inorganic particle to the organic polymer exceeds 91:9, that is, in the case where the proportion of the organic polymer is below 9/100, the organic polymer cannot bind the inorganic particle in some cases.

By the way, in the electrolyte-negative electrode structure according to the present invention, the inorganic particle has a higher reduction potential vs. a potential of the Li+/Li electrode reaction than the high-capacity material capable of intercalating lithium ions in some cases. In such cases, when the electrolyte-negative electrode structure is used for a lithium ion secondary battery, aside from the battery reaction, an oxidation-reduction reaction at the interface between the solid electrolyte and the negative electrode active material layer occurs, and the solid electrolyte is thereby reduced and deteriorated in some cases.

Then, in the electrolyte-negative electrode structure according to the present invention, the inorganic particle preferably comprises a composite metal oxide represented by the chemical formula: Li_{7-y}La₃₋ₓAₓZr_{2-y}M_{y}O₁₂ (wherein A is any one metal selected from the group consisting of Y, Nd, Sm and Gd; x is in the range of 0≦x<3; M is Nb or Ta; and y is in the range of 0≦y<2), and having a garnet-type structure.

The inorganic particle has a lower reduction potential vs. a potential of the Li+/Li electrode reaction than a high-capacity material capable of intercalating lithium ions, such as silicon, silicon oxide or tin oxide. Therefore, when an electrolyte-negative electrode structure in which the inorganic particle comprises the composite metal oxide is used for a lithium ion secondary battery, aside from the battery reaction, an oxidation-reduction reaction at the interface between the solid electrolyte and the negative electrode active material layer is suppressed, and the solid electrolyte can thereby be prevented from being reduced and deteriorated.

In the electrolyte-negative electrode structure according to the present invention, for example, a thermoplastic organic polymer selected from the group consisting of polyethylene oxide, polyvinylidene fluoride and polyacrylonitrile is usable as the polymer gel.

As the organic polymer, one or two or more resins selected from the group consisting of polyolefin, fluororesins, polyimide, acrylic resins, styrene-butadiene rubber and carboxymethylcellulose are usable.

As the current collector, a foil or a plate comprising copper or a stainless steel is usable.

As the material capable of intercalating lithium ions constituting the negative electrode active material layer, silicon, tin, and an oxide including these metal or an alloy thereof is usable.

In addition, the electrolyte-negative electrode structure according to the present invention can be applied to a lithium ion secondary battery.

### BRIEF DESCRIPTION OF THE DRAWINGS

FIG. 1 is an illustrative cross-sectional diagram showing a constitution of a lithium ion secondary battery comprising an electrolyte-negative electrode structure according to the present embodiment;

FIG. 2 is a cross-sectional image showing a joining surface of an electrolyte-negative electrode structure according to the present embodiment;

FIG. 3 is a graph showing relationships between charge and discharge capacities and cell voltages at the 50th cycle of lithium ion secondary batteries comprising electrolyte-negative electrode structures according to the present embodiment; and

FIG. 4 is a graph showing cycle performances of lithium ion secondary batteries comprising electrolyte-negative electrode structures according to the present embodiment.

### DETAILED DESCRIPTION OF THE PREFERRED EMBODIMENTS

Then, the embodiment according to the present invention will be described in more detail by reference to the attached drawings.

As shown in FIG. 1, the lithium ion secondary battery 1 according to the present embodiment comprises a negative electrode 4 in which a negative electrode active material layer 3 is formed on a negative electrode current collector 2, a positive electrode 5, and a solid electrolyte 6 disposed between the negative electrode 4 and the positive electrode 5. In the lithium ion secondary battery 1, the negative electrode active material layer 3 and the solid electrolyte 6 are unified and an electrolyte-negative electrode structure 7 comprising the negative electrode current collector 2, the negative electrode active material layer 3 and the solid electrolyte 6 is thus formed.

As the negative electrode current collector 2, for example, a foil or a plate comprising copper, a stainless steel or the like is usable.

The negative electrode active material layer 3 comprises a high-capacity material capable of intercalating lithium ions, and for example, silicon, tin, an oxide thereof or an alloy thereof is usable.

The negative electrode 4 can be obtained, for example, by forming a film on the negative electrode current collector 2 by using a paste formed by mixing the high-capacity material capable of intercalating lithium ions, an electroconductive auxiliary agent, a binder and a solvent, and drying the obtained film to thereby form the negative electrode active material layer 3.

As the electroconductive auxiliary agent, for example, Ketjen black, acetylene black and flaky copper powder are usable. As the binder, for example, polyimide, PVDF (polyvinylidene fluoride) and SBR (styrene-butadiene rubber) are usable. As the solvent, for example, distilled water and N-methyl-2-pyrrolidinone (NMP) are usable. Examples of a method for forming the film include a casting method using a doctor blade.

As the positive electrode 5, a positive electrode containing a positive electrode active material can be used. As the positive electrode active material, for example, a transition metal oxide, a composite metal oxide comprising lithium and a transition metal oxide, lithium iron phosphate having an olivine structure, a transition metal sulfide and an organic compound are usable.

Examples of the transition metal oxide include MnO, V₂O₃, V₆O₁₂ and TiO₂. Examples of the composite metal oxide comprising lithium and a transition metal oxide include lithium nickelate, lithium cobaltate and lithium manganate. Examples of the transition metal sulfide include TiS, FeS and MoS₂. Examples of the organic compound include polyaniline, polypyrrole, polyacene, disulfide-based compounds, polysulfide-based compounds and N-fluoropyridinium salts.

The solid electrolyte 6 comprises an inorganic particle having lithium ion conductivity, an organic polymer binding the inorganic particle and capable of being impregnated with a polymer gel, and the polymer gel holding an electrolyte solution having lithium ion conductivity and being impregnated in the organic polymer.

The inorganic particle usable comprises a composite metal oxide represented by the chemical formula: Li_{7-y}La₃₋ₓAₓZr_{2-y}M_{y}O₁₂ and having a garnet-type structure. In the chemical formula, A is any one metal selected from the group consisting of Y, Nd, Sm and Gd; x is in the range of 0≦x<3; M is Nb or Ta; and y is in the range of 0≦y<2.

The inorganic particle comprising the composite metal oxide can be obtained by firing a mixed raw material prepared by mixing a Li compound, a La compound and a Zr compound. At this time, as required, a compound of any one metal selected from the group consisting of Y, Nd, Sm and Gd and a compound of Nb or Ta may further be mixed into the mixed raw material.

Examples of the Li compound include LiOH or hydrate thereof, Li₂CO₃, LiNO₃ and CH₃COOLi. Examples of the La compound include La₂O₃, La(OH)₃, La₂(CO₃)₃, La(NO₃)₃ and (CH₃COO)₃La. Examples of the Zr compound include Zr₂O₂, ZrO(NO₃)₂, ZrO(CH₃COO)₂, Zr(OH)₂CO₃ and ZrO₂.

Examples of the Y compound include Y₂O₃, Y₂(CO₃)₃, Y(NO₃)₃ and (CH₃COO)₃Y. Examples of the Nd compound include Nd₂O₃, Nd₂(CO₃)₃, Nd(NO₃)₃ and (CH₃COO)₃Nd. Examples of the Sm compound include Sm₂O₃, Sm₂(CO₃)₃, Sm(NO₃)₃ and (CH₃COO)₃Sm. Examples of the Gd compound include Gd₂O₃, Gd₂(CO₃)₃, Gd(NO₃)₃ and (CH₃COO)₃Gd.

Examples of the Nb compound include Nb₂O₅, NbO₂, NbCl₅ and LiNbO₃. Examples of the Ta compound include Ta₂O₅, TaCl₅ and LiTaO₃.

The firing involves first crushing and mixing the mixed raw material by a crushing and a mixing apparatus such as a ball mill and a mixer, and thereafter primarily firing the mixture at a temperature in the range of 850 to 950° C. for a period of time in the range of 5 to 7 hours. Then, a fired body obtained by the primary firing is again crushed and mixed by a crushing and a mixing apparatus such as a ball mill and a mixer, and thereafter holding and secondarily firing the mixture in the temperature range of 1,000 to 1,200° C. for a period of time in the range of 6 to 12 hours.

The composite metal oxide obtained by the firing preferably has a particle diameter of 20 μm or smaller for use as the lithium ion-conductive material. In the case where a lot of particles having a particle diameter larger than 20 μm are contained, the composite metal oxide obtained by the firing is made to have a particle diameter of 20 μm or smaller by crushing the composite metal oxide, for example, by a crushing and a mixing apparatus such as a ball mill and a mixer.

The organic polymer constituting the solid electrolyte 6 is required to act as a binder for the inorganic particle, be capable of being impregnated with the polymer gel, and be stable in the operating voltage of a lithium secondary battery. As the organic polymer, for example, one or two or more resins selected from the group consisting of polyolefins such as polyethylene and polypropylene, fluororesins such as polytetrafluoroethylene (PTFE) and polyvinylidene fluoride, polyimide, acrylic resins, styrene-butadiene rubber (SBR) and carboxymethylcellulose (CMC) are usable.

The polymer gel constituting the solid electrolyte 6 comprises an electrolyte solution comprising a lithium salt as a supporting salt and an organic solvent dissolving the lithium salt, and a polymer to be impregnated with the electrolyte solution. The polymer gel preferably contains the electrolyte solution in the range of 30 to 95 mass % for simultaneous satisfaction of both the ionic conductivity and the mechanical strength as a polymer gel.

As the lithium salt, for example, LiPF₆, LiBF₄, LiClO₄, LiCF₃SO₃ and LiN(CF₃SO₂)₂ are usable.

As the organic solvent, for example, cyclic esters such as ethylene carbonate (EC), propylene carbonate (PC) and γ-butyrolactone (γ-BL), and chain esters such as diethyl carbonate (DEC), ethyl methyl carbonate (EMC) and dimethyl carbonate (DMC) are usable.

As a polymer for constituting the polymer gel, for example, thermoplastic organic polymers such as polyethylene oxide (PEO), polyvinylidene fluoride (PVDF) and polyacrylonitrile (PAN) are usable.

The inorganic particle and the organic polymer constituting the solid electrolyte 6 are preferably made to be in a volume ratio in the range of 54:46 to 91:9, and the inorganic particle, the polymer gel and the organic polymer are preferably made to be in a volume ratio in the range of 77:8:15 to 38:32:30. Making such a ratio allows the inorganic particle and the polymer gel to be homogeneously dispersed in the solid electrolyte 6 and the conduction path of lithium ions to be formed across the entire of the solid electrolyte 6, whereby excellent lithium ion conductivity can be provided. The organic polymer binds the inorganic particle, whereby a structure as the solid electrolyte 6 can securely be formed.

In the electrolyte-negative electrode structure 7, the solid electrolyte 6 and the negative electrode active material layer 3 are joined and unified through the organic polymer.

The electrolyte-negative electrode structure 7 can be formed, for example, as follows. First, a paste formed by mixing the inorganic particle and the organic polymer is formed as a film on the negative electrode active material layer 3 of the negative electrode 4 by a casting method using a doctor blade, and thereafter dried to thereby form a laminate comprising the negative electrode 4 and a dried body of the paste. Then, the obtained laminate is pressurized to join and unify the negative electrode 4 and the dried body of the paste to thereby form a joined body.

Then, an electrolyte solution having lithium ion conductivity and a powder of a polymer constituting the polymer gel are mixed to thereby prepare a sol-form liquid. Then, the obtained sol-form liquid is impregnated in the joined body under pressure, and thereafter naturally cooled to thereby gelatinize the sol-form liquid.

As a result, the joined body in which the sol-form liquid introduced under pressure has been gelatinized forms the solid electrolyte 6. The solid electrolyte 6 and the negative electrode active material layer 3 are joined and unified through the organic polymer constituting the solid electrolyte 6 to thereby form the electrolyte-negative electrode structure 7 comprising the negative electrode current collector 2, the negative electrode active material layer 3 and the solid electrolyte 6.

In the electrolyte-negative electrode structure 7 according to the present embodiment, the negative electrode active material layer 3 formed on the negative electrode current collector 2 and the solid electrolyte 6 are unified. As a result, in the electrolyte-negative electrode structure 7, even if the negative electrode active material layer 3 repeats expansion and contraction along with charging and discharging, stresses generated by the repetition of expansion and contraction can be relaxed by the solid electrolyte 6.

Therefore, according to the electrolyte-negative electrode structure 7 according to the present embodiment, exfoliation of the negative electrode active material layer 3 from the negative electrode current collector 2 can be prevented and a decrease in the cycle performance can thereby be suppressed.

In the electrolyte-negative electrode structure 7 according to the present embodiment, since the contact of the solid electrolyte 6 and the negative electrode active material layer 3 is good, Li ions can easily be conducted between the solid electrolyte 6 and the negative electrode active material layer 3. In the electrolyte-negative electrode structure 7, the interfacial resistance between the solid electrolyte 6 and the negative electrode active material layer 3 is thereby lowered to be thereby able to suppress the overvoltage.

The inorganic particle constituting the solid electrolyte 6 has a reduction potential in the range of −1.67 to −0.06 V vs. a potential of the Li⁺/Li electrode reaction. On the other hand, in the high-capacity material capable of intercalating lithium ions constituting the negative electrode active material layer 3, silicon has a reduction potential of 0.5 V; silicon oxide, 0.5 V; and tin oxide, 1.0 V. That is, the inorganic particle has a lower reduction potential than the high-capacity material capable of intercalating lithium ions. Therefore, when the electrolyte-negative electrode structure 7 according to the present embodiment is used for a lithium ion secondary battery, aside from the battery reaction, the occurrence of an oxidation-reduction reaction at the interface between the solid electrolyte 6 and the negative electrode active material layer 3 is suppressed, and the solid electrolyte 6 can thereby be prevented from being reduced and deteriorated.

Here, the reduction potential can be calculated using the first-principle calculation method, specifically, VASP (Vienna Ab initio Simulation Package) being the first-principle electronic state calculation program, by GGA (Generalized Gradient Approximation)/PAW (Projector Augmented Wave) method under the condition of a cutoff energy of 480 eV and k points=3×3×3.

Since the inorganic particle has lithium ion conductivity, lithium ions can be diffused uniformly from the solid electrolyte 6 to the negative electrode active material layer 3 at the interface between the solid electrolyte 6 and the negative electrode active material layer 3. The generation of dendrite in the interior of the solid electrolyte 6 along with the repetition of charging and discharging can thereby be prevented.

Since the polymer gel constituting the solid electrolyte 6 has a low flowability, the diffusion of dissolved gases can be suppressed more than in the case of using an electrolyte solution singly. Permeation of dissolved gases such as carbon dioxide and oxygen generated by decomposition of an electrolyte solution and overcharging caused at the positive electrode 5 in the charging time through the solid electrolyte 6 can thereby be prevented and the reaction of the negative electrode active material layer 3 and the dissolved gases can thereby be suppressed.

Further in the electrolyte-negative electrode structure 7 according to the present embodiment, since the solid electrolyte 6 and the negative electrode active material layer 3 of the negative electrode 4 are unified, even in the case where the solid electrolyte 6 is formed as a thin film, excellent handleability can be provided and a required strength can also be provided.

Then, Examples and Comparative Examples of the present invention will be described.

### Example 1

[1. Preparation of an Inorganic Particle]

In the present Example, first, lithium hydroxide monohydrate was subjected to a dehydration treatment by heating in a vacuum atmosphere at a temperature of 350° C. for 6 hours to thereby obtain anhydrous lithium hydroxide. Lanthanum oxide was subjected to a dehydration and decarbonation treatment by heating in the air atmosphere at a temperature of 950° C. for 24 hours.

Then, zirconium oxide was added to and mixed with the obtained anhydrous lithium hydroxide and the dehydrated and decarbonated lanthanum oxide in a molar ratio of Li:La:Zr=7.7:3:2, and crushed and mixed using a planetary ball mill at a rotation frequency of 360 rpm for 3 hours to thereby obtain a mixed raw material.

The obtained mixed raw material was accommodated in an alumina-made crucible, and held and primarily fired in the air atmosphere at a temperature of 900° C. for 6 hours to thereby obtain a powdery primarily fired material.

Then, the obtained primarily fired material was accommodated in an alumina-made crucible, and held and secondarily fired in the air atmosphere at a temperature of 1,050° C. for 6 hours to thereby obtain an inorganic particle. The inorganic particle is represented by the chemical formula: Li₇La₃Zr₂O₁₂, comprises a composite metal oxide having a garnet-type structure, and has lithium ion conductivity. The above chemical formula Li₇La₃Zr₂O₁₂ corresponds to the case where in the above Li_{7-y}La₃₋ₓAₓZr_{2-y}M_{y}O₁₂, x=0 and y=0.

[2. Preparation of a Paste Containing the Inorganic Particle and an Organic Polymer]

Then, for an organic polymer, a 40-mass % styrene-butadiene rubber aqueous dispersion liquid (hereinafter, abbreviated to SBR aqueous dispersion liquid) and a 1.5-mass % carboxymethylcellulose (CMC) aqueous solution are used. The obtained inorganic particle, the SBR aqueous dispersion liquid and the CMC aqueous solution were mixed in a mass ratio of 98:1:1 in terms of solid content, and stirred using a rotating and revolving mixer to thereby obtain a mixture. Then, the obtained mixture was defoamed, and thereafter mixed using a thin-film vortex mixer to make a paste containing the inorganic particle and the organic polymer to thereby prepare a first paste in which the inorganic particle, the SBR and the CMC were dispersed.

[3. Fabrication of a Negative Electrode]

Then, a Si powder (average particle diameter: 10 μm), a Ketjen black (trade name: EC600JD, made by Lion Corporation, hereinafter, abbreviated to KB), a flaky copper powder (made by Mitsui Mining & Smelting Co., Ltd.), and a polyamic acid solution in which 40 mass % of a polyamic acid was dissolved in N-methyl-2-pyrrolidone (trade name: SKYBOND700, made by I.S.T Corporation) were mixed in a mass ratio of 75:5:5:15, and stirred using a rotating and revolving mixer to thereby obtain a mixture. Then, the obtained mixture was defoamed, and thereafter mixed using a thin-film vortex mixer to thereby obtain a second paste in which the Si powder, the KB, the copper powder and the polyamic acid were dispersed.

Then, a thin film comprising the obtained second paste was formed on a negative electrode current collector 2 comprising an about 40 μm-thick electrolytic copper foil (made by Fukuda Metal Foil & Powder Co., Ltd.) by a casting method using a doctor blade. Thereafter, the thin film was heated under a vacuum of 200 Pa at a temperature of 300° C. for 3 hours to polymerize and imidize the polyamic acid to thereby form a negative electrode active material layer 3 having a thickness of about 50 μm. As a result, a negative electrode 4 in which the negative electrode active material layer 3 was formed on the negative electrode current collector 2 was obtained.

[4. Fabrication of an Electrolyte-Negative Electrode Structure]

Then, a thin film comprising the first paste was formed on the obtained negative electrode active material layer 3 of the negative electrode 4 by a casting method using a doctor blade, and heated to be dried at a temperature of 70° C. for 2 hours to thereby form a laminate comprising the negative electrode 4 and a dried body 6a of the paste. Then, the obtained laminate was cut into a 17 mm-diameter circle, and thereafter pressurized at a pressure of 20 MPa to join and unify the negative electrode 4 and the dried body 6a of the first paste to thereby form a joined body. Thereafter, the joined body was heated under a vacuum of 200 Pa at a temperature of 150° C.

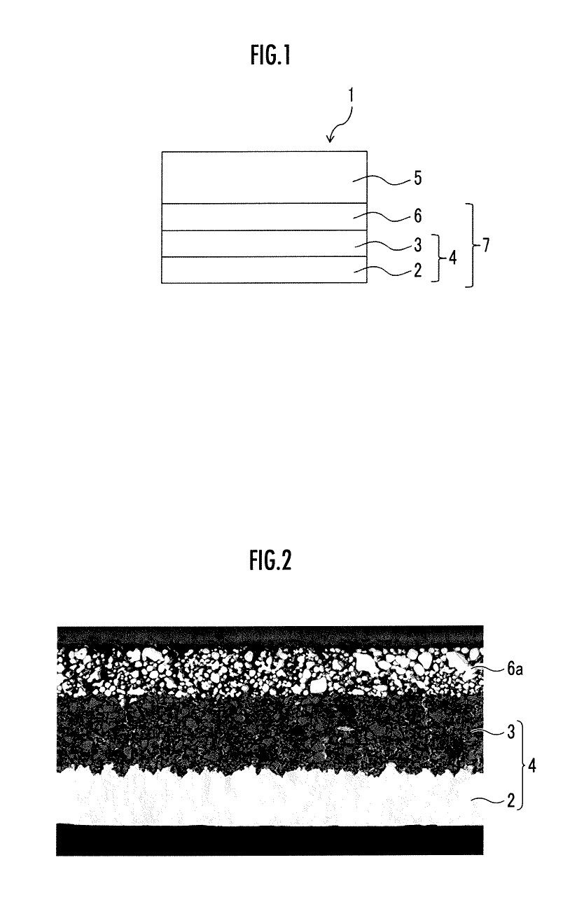

Then, the cross-section of the joined body after the heating was observed by a scanning electron microscope (SEM). FIG. 2 shows a cross-sectional image of the joined body. From FIG. 2, it is clear that the dried body 6a comprising the inorganic particle and the organic polymer, and the negative electrode active material layer 3 are unified.

Then, LiPF₆ as a supporting salt was dissolved in a concentration of 0.8 mol/L in an organic solvent in which ethylene carbonate (EC) and propylene carbonate (PC) were mixed in a volume ratio of 1:1 to thereby prepare an electrolyte solution having lithium ion conductivity. 88 parts by mass of the obtained electrolyte solution and 12 parts by mass of a polyacrylonitrile powder (molecular weight: 150,000) were mixed in an argon atmosphere at a temperature of 120° C. to thereby prepare a sol-form liquid.

Then, the joined body was impregnated with the sol-form liquid under pressure, and allowed to stand still at room temperature for 12 hours to fill pores present in the joined body with the sol-form liquid, and naturally cooled to thereby gelatinize the sol-form liquid. From the above, an electrolyte-negative electrode structure 7 was formed in which the solid electrolyte 6 and the negative electrode active material layer 3 of the negative electrode 4 were unified. In the obtained electrolyte-negative electrode structure 7, the volume ratio of the inorganic particle to the organic polymer comprising the SBR and the CMC was 81.8:18.2 in terms of solid content.

[5. Fabrication of a Positive Electrode and a Lithium Ion Secondary Battery]

Then, a carbon-coated LiFePO₄ powder (made by Hohsen Corp.), a Ketjen black (trade name: EC600JD, made by Lion Corporation) as an electroconductive auxiliary agent, and a polytetrafluoroethylene (PTFE) as a binder were mixed in a mass ratio of 88:6:6 using ethanol as a solvent to thereby obtain a positive electrode mixture.

The obtained positive electrode mixture was molded in a pellet-form by a 16 mm-diameter die, and thereafter bonded under pressure on a stainless steel-made mesh (Japanese Industrial Standards SUS316L) as a positive electrode current collector to thereby obtain a positive electrode 5 comprising LiFePO₄.

Then, the positive electrode 5 was tightly contacted with the solid electrolyte 6 of the electrolyte-negative electrode structure 7 obtained in the present Example to thereby fabricate a lithium ion secondary battery 1.

[6. Evaluation of the Cycle Performance of the Lithium Ion Secondary Battery]

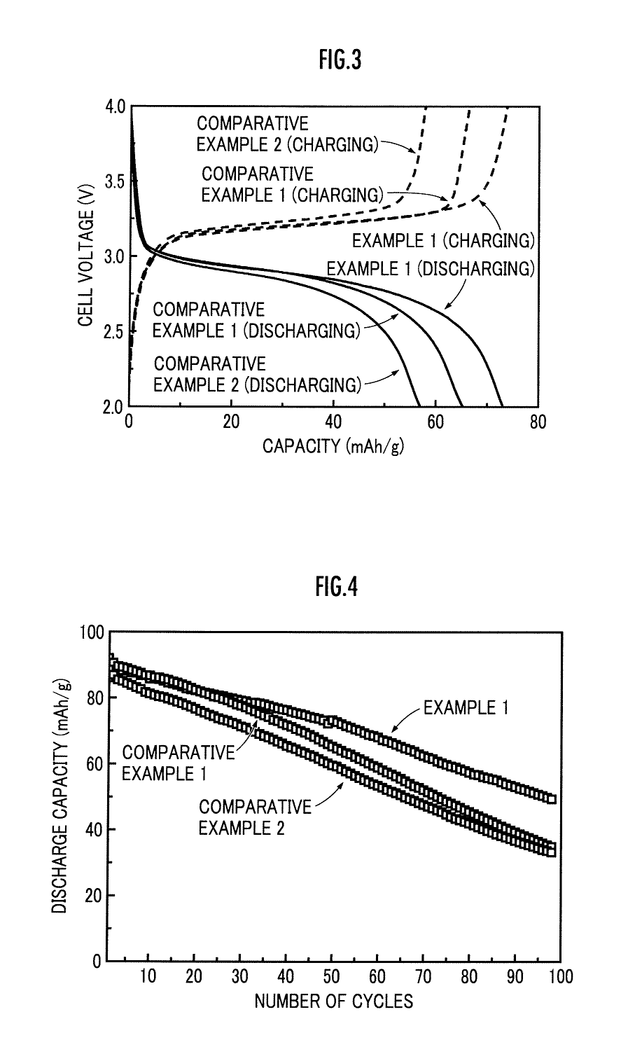

The lithium ion secondary battery 1 comprising the electrolyte-negative electrode structure 7 obtained in the present Example was loaded on an electrochemical tester (made by Toho Technical Research Co., Ltd.). Then, an operation, in which at a temperature of 25° C., charging was carried out until the cell voltage reached 4.0 V by applying a current between the positive electrode 5 and the negative electrode 4, and thereafter, discharging was carried out until the cell voltage reached 2.0 V, was repeated by 98 cycles. The application of the current was carried out at a current density of 0.375 mA/cm². The relationship between the cell voltage and the charge and discharge capacities at the 50th cycle is shown in FIG. 3, and discharge capacities at each cycle termination time are shown in FIG. 4. The discharge capacity retention at the 80th cycle to a discharge capacity at the 10th cycle is shown in Table 1.

### Comparative Example 1

In the present Comparative Example, a lithium ion secondary battery was fabricated wholly the same as in Example 1, except for forming an electrolyte layer by dissolving LiPF₆ as a supporting salt in a concentration of 1 mol/L in an organic solvent in which ethylene carbonate (EC) and diethyl carbonate (DEC) were mixed in a volume ratio of 3:7 to thereby prepare an electrolyte solution having lithium ion conductivity, and impregnating a polyethylene microporous membrane (diameter: 17 mm, thickness: 25 μm, porosity: 46%) as a separator with the electrolyte solution.

The lithium ion secondary battery obtained in the present Comparative Example had wholly the same constitution as the lithium ion secondary battery 1 shown in FIG. 1, except that the electrolyte layer corresponds to a liquid electrolyte, and the electrolyte layer and the negative electrode active material layer 3 of the negative electrode 4 are not unified.

Then, the cycle performance was evaluated wholly the same as in Example 1, except for using the lithium ion secondary battery obtained in the present Comparative Example. The relationship between the cell voltage and the charge and discharge capacities at the 50th cycle is shown in FIG. 3, and discharge capacities at each cycle termination time are shown in FIG. 4. The discharge capacity retention at the 80th cycle to a discharge capacity at the 10th cycle is shown in Table 1.

### Comparative Example 2

In the present Comparative Example, a lithium ion secondary battery was fabricated wholly the same as in Example 1, except for preparing a sol-form liquid wholly as in the sol-form liquid of Example 1, and impregnating a polyethylene microporous membrane (diameter: 17 mm, thickness: 50 μm, porosity: 93%) as a separator with the sol-form liquid to thereby form an electrolyte layer.

The lithium ion secondary battery obtained in the present Comparative Example has wholly the same constitution as the lithium ion secondary battery 1 shown in FIG. 1, except that the electrolyte layer corresponds to a solid electrolyte, and the electrolyte layer and the negative electrode active material layer 3 of the negative electrode 4 are not unified.

Then, the cycle performance was evaluated wholly the same as in Example 1, except for using the lithium ion secondary battery obtained in the present Comparative Example. The relationship between the cell voltage and the charge and discharge capacities at the 50th cycle is shown in FIG. 3, and discharge capacities at each cycle termination time are shown in FIG. 4. The discharge capacity retention at the 80th cycle to a discharge capacity at the 10th cycle is shown in Table 1.

### Example 2

In the present Example, an electrolyte-negative electrode structure 7 was formed wholly the same as in Example 1, except for preparing a first paste by mixing the inorganic particle, the SBR aqueous dispersion liquid and the CMC aqueous solution in a mass ratio of 95:2.5:2.5 in terms of solid content. In the obtained electrolyte-negative electrode structure 7, the volume ratio of the inorganic particle to the organic polymer comprising the SBR and the CMC was 54.4:45.6 in terms of solid content.

A lithium ion secondary battery 1 was fabricated wholly the same as in Example 1, except for using the electrolyte-negative electrode structure 7 obtained in the present Example, and the cycle performance was evaluated. The discharge capacity retention at the 80th cycle to a discharge capacity at the 10th cycle is shown in Table 1.

### Example 3

In the present Example, an electrolyte-negative electrode structure 7 was formed wholly the same as in Example 1, except for preparing a first paste by mixing the inorganic particle, the SBR aqueous dispersion liquid and the CMC aqueous solution in a mass ratio of 99:0.5:0.5. In the obtained electrolyte-negative electrode structure 7, the volume ratio of the inorganic particle to the organic polymer comprising the SBR and the CMC was 90.9:9.1 in terms of solid content.

A lithium ion secondary battery 1 was fabricated wholly the same as in Example 1, except for using the electrolyte-negative electrode structure 7 obtained in the present Example, and the cycle performance was evaluated. The discharge capacity retention at the 80th cycle to a discharge capacity at the 10th cycle is shown in Table 1.

TABLE 1

| | 10th cycle | 80th cycle | Discharge Capacity |
|---|---|---|---|
| | (mAh/g) | (mAh/g) | Retention (%) |
| Example 1 | 85.7 | 57.2 | 66.7 |
| Example 2 | 70.3 | 43.4 | 61.7 |
| Example 3 | 64.1 | 42.5 | 66.3 |
| Comparative | 86.6 | 45.4 | 52.4 |
| Example 1 | | | |
| Comparative | 81.2 | 41.8 | 51.5 |
| Example 2 | | | |

The lithium ion secondary batteries 1 of Examples 1 to 3 each comprise an electrolyte-negative electrode structure 7 in which a solid electrolyte 6 comprising the inorganic particle, the polymer gel and the organic polymer, and a negative electrode active material layer 3 of a negative electrode 4 are unified.

In contrast, the lithium ion secondary battery of Comparative Example 1 comprises an electrolyte layer (liquid electrolyte) in which a separator was impregnated with an electrolyte solution; the lithium ion secondary battery of Comparative Example 2 comprises an electrolyte layer (solid electrolyte) in which a separator was impregnated with the same polymer gel as in Example 1; and in either case, the electrolyte layer and the negative electrode active material layer 3 of the negative electrode 4 are not unified.

Seeing from FIG. 3 that the lithium ion secondary battery 1 of Example 1 has larger charge and discharge capacities than the lithium ion secondary batteries of Comparative Example 1 and Comparative Example 2, it is clear that the charge and discharge overvoltages are suppressed.

In the lithium ion secondary batteries of Comparative Examples 1 and 2, since the electrolyte layer and the negative electrode active material layer of the negative electrode only simply contacted each other, it is conceivable that contact of the electrolyte layer with the negative electrode active material layer became insufficient, and the overvoltage rose. In contrast, in the lithium ion secondary battery 1 of Example 1, since the solid electrolyte 6 and the negative electrode active material layer 3 of the negative electrode 4 were unified, it is conceivable that the solid electrolyte 6 and the negative electrode active material layer 3 well contacted each other, and the overvoltage could be suppressed.

It is also clear from FIG. 4 that the lithium ion secondary battery 1 of Example 1 exhibits a lower decrease in the discharge capacity along with an increase in the number of cycles than the lithium ion secondary batteries of Comparative Example 1 and Comparative Example 2.

In the lithium ion secondary batteries of Comparative Examples 1 and 2, the electrolyte layer and the negative electrode active material layer of the negative electrode only simply contact each other. Therefore, in the lithium ion secondary batteries of Comparative Examples 1 and 2, it is conceivable that stresses generated in the negative electrode active material layer of the negative electrode along with repetition of charging and discharging could not be relaxed by the electrolyte layer, and the negative electrode active material layer generated cracks and exfoliated, thus decreasing the cycle performance.

In contrast, in the lithium ion secondary battery 1 of Example 1, the solid electrolyte 6 and the negative electrode active material layer 3 of the negative electrode 4 are unified. Therefore, in the lithium ion secondary battery 1 of Example 1, it is conceivable that stresses generated in the negative electrode active material layer 3 along with repetition of charging and discharging were relaxed by the solid electrolyte 6, thus suppressing a decrease in the cycle performance.

It is also clear from Table 1 that the lithium ion secondary batteries 1 of Examples 1 to 3 each has a larger discharge capacity retention at the 80th cycle and a better cycle performance than the lithium ion secondary batteries of Comparative Example 1 and Comparative Example 2.

What is claimed is:

1. An electrolyte-negative electrode structure used for a lithium ion secondary battery, comprising:
a negative electrode in which a negative electrode active material layer comprising a material capable of intercalating lithium ions is formed on a current collector; and
a solid electrolyte comprising an inorganic particle having lithium ion conductivity, a polymer gel to be impregnated with an electrolyte solution having lithium ion conductivity, and an organic polymer acting as a binder for the inorganic particle and being capable of being impregnated with the polymer gel,
wherein the negative electrode active material layer and the solid electrolyte are unified through the organic polymer as a medium.

2. The electrolyte-negative electrode structure according to claim 1, wherein a volume ratio of the inorganic particle to the organic polymer is in the range of 54:46 to 91:9.

3. The electrolyte-negative electrode structure according to claim 1, wherein the inorganic particle comprises a composite metal oxide represented by a chemical formula: Li_{7-y}La₃₋ₓAₓZr_{2-y}M_{y}O₁₂ (wherein A is any one metal selected from a group consisting of Y, Nd, Sm and Gd; x is in the range of 0≦x<3; M is Nb or Ta; and y is in the range of 0≦y<2), and having a garnet-type structure.

4. The electrolyte-negative electrode structure according to claim 1, wherein the polymer gel comprises a thermoplastic organic polymer selected from a group consisting of polyethylene oxide, polyvinylidene fluoride and polyacrylonitrile.

5. The electrolyte-negative electrode structure according to claim 1, wherein the organic polymer comprises one or two or more resins selected from a group consisting of polyolefins, fluororesins, polyimide, acrylic resins, styrene-butadiene rubber and carboxymethylcellulose.

6. The electrolyte-negative electrode structure according to claim 1, wherein the current collector is a foil or a plate comprising copper or a stainless steel.

7. The electrolyte-negative electrode structure according to claim 1, wherein the material capable of intercalating lithium ions is silicon, tin, an oxide thereof or an alloy thereof.

8. A lithium ion secondary battery comprising an electrolyte-negative electrode structure comprising:
a negative electrode in which a negative electrode active material layer comprising a material capable of intercalating lithium ions is formed on a current collector; and
a solid electrolyte comprising an inorganic particle having lithium ion conductivity, a polymer gel to be impregnated with an electrolyte solution having lithium ion conductivity, and an organic polymer acting as a binder for the inorganic particle and being capable of being impregnated with the polymer gel,
wherein the negative electrode active material layer and the solid electrolyte are unified through the organic polymer as a medium.
